(19) United States
(12) Patent Application Publication
(10) Pub. No.: US 2026/0358542 A1
(43) Pub. Date: Nov. 12, 2026

(54) POLARIZING PLATE AND OPTICAL DISPLAY APPARATUS

(71) Applicant: HOARDSUN HENGXIN(WUXI) MATERIALS CO., LTD., Wuxi (CN)

(72) Inventors: Sanghum LEE, Wuxi (CN); Junghun YOU, Wuxi (CN); Yongun JUNG, Wuxi (CN); Boemdeok LEE, Wuxi (CN); Kiyong KIM, Wuxi (CN); KyoungMin CHO, Wuxi (CN)

(73) Assignee: HOARDSUN HENGXIN(WUXI) MATERIALS CO., LTD., Wuxi (CN)

(21) Appl. No.: 19/672,832

(22) Filed: May 11, 2026

(30) Foreign Application Priority Data
May 12, 2025 (KR) 10-2025-0060944

(51) Int. Cl. G02B 5/30

(52) U.S. Cl. CPC G02B 5/3041

(57) ABSTRACT

Provided are a polarizing plate and an optical display apparatus including the same are provided, the polarizing plate including: a polarizer; and an upper protective film positioned on a light emission surface of the polarizer, wherein the upper protective film includes an anti-glare layer, wherein the anti-glare layer does not include one or more of inorganic particles and organic particles, and wherein the upper protective film has Sal of 7 μm or more and an internal haze of 2% or less.

This application claims priority to Korean Patent Application No. 10-2025-0060944, titled “POLARIZING PLATE AND OPTICAL DISPLAY APPARATUS”, filed on May 12, 2025, with the Korean Intellectual Property Office, which is incorporated herein by reference in its entirety.

### FIELD

The present invention relates to a polarizing plate and an optical display apparatus.

### BACKGROUND

An optical display apparatus includes a polarizing plate to improve optical characteristics. The polarizing plate may include a polarizer and a protective film laminated on at least one surface of the polarizer.

The protective film may consist solely of a polymer substrate film, but additional functions may be provided by additionally forming a functional coating layer on a substrate film. The functional coating layer may be an anti-glare layer, a low-reflection layer, a hard coating layer or the like.

A film including the anti-glare layer and low-reflection layer may be used as a protective film for the polarizing plate. By including the anti-glare layer and the low-reflection layer, specular reflection and reflectance can be reduced simultaneously. The anti-glare layer may provide an anti-glare effect by including micro-sized particles. However, the anti-glare layer may exhibit particle clumping or non-uniform dispersion, and micro-scattering and Rayleigh scattering caused by the particles may be affected by wavelength, resulting in a difference in reflected colors between the front surface and the side surface. In addition, external irregularities created by particles can cause a reduction in the bright-room contrast ratio.

The background art of the present invention is disclosed in Korean Patent Laid-Open Publication No. 10-2120989 and the like.

### SUMMARY

According to one embodiment, provided is a polarizing plate that provides the effects of improving brightness, improving a bright-room contrast ratio and improving a dark-room contrast ratio.

According to another embodiment, provided is a polarizing plate that minimizes a difference in reflected color values between the front surface and the side surface.

According to still another embodiment, provided is a polarizing plate that provides a glare-free effect that minimizes image reflection caused by external light.

According to an embodiment, provided is a polarizing plate.

The polarizing plate includes: a polarizer; and an upper protective film positioned on a light emission surface of the polarizer, wherein the upper protective film includes an anti-glare layer, wherein the anti-glare layer does not include one or more of inorganic particles and organic particles, and wherein the upper protective film has Sal of 7 μm or more and an internal haze of 2% or less.

According to another embodiment, provided is an optical display apparatus.

The optical display apparatus includes the polarizing plate.

According to one embodiment, provided is a polarizing plate that provides the effects of improving brightness, improving a bright-room contrast ratio and improving a dark-room contrast ratio.

According to another embodiment, provided is a polarizing plate that minimizes a difference in reflection color values between the front surface and the side surface.

According to still another embodiment, provided is a polarizing plate that provides an effect of improving specular reflection.

### BRIEF DESCRIPTION OF THE DRAWINGS

FIG. 1 is a cross-sectional diagram of a polarizing plate of one embodiment.

FIG. 2 is a cross-sectional diagram of a polarizing plate of another embodiment.

FIG. 3 shows the color dispersion according to haze when applying the polarizing plates of the examples and comparative examples. In FIG. 3, the X-axis represents haze (unit: %), and the Y-axis represents color dispersion Ea*b* (unit: none).

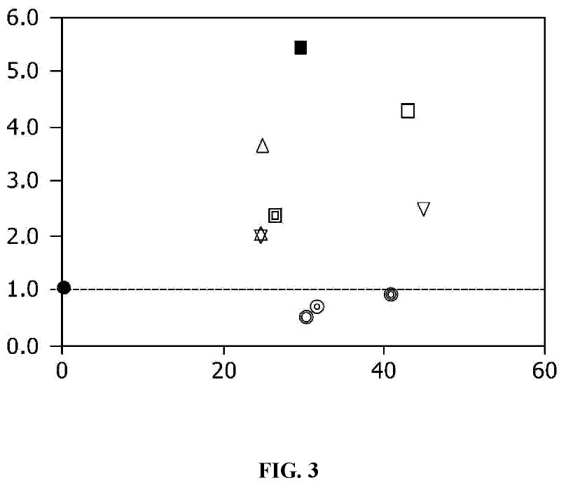

In FIG. 3, with regard to the reflection color dispersion distance between the front surface and side surface of a WOLED panel, when AG without particles is applied, the Aa*b* value, which is a difference between the front surface and side surface distance values of color coordinates a* and b*, is distributed at 1.0 or less, but when particles are included, the dispersion has a distance exceeding 1.0, resulting in a shape where the reflection color dispersion increases with each viewing angle.

FIG. 4 shows the reflection color dispersion a* and b* when applying the polarizing plate of Example 1. In FIG. 4, the X-axis represents a* (unit: none), and the Y-axis represents b* (unit: none).

FIG. 5 shows the reflection color scatter a* and b* when the polarizing plate of Comparative Example 1 is applied. In FIG. 5, the X-axis is a* (unit: none), and the Y-axis is b* (unit: none).

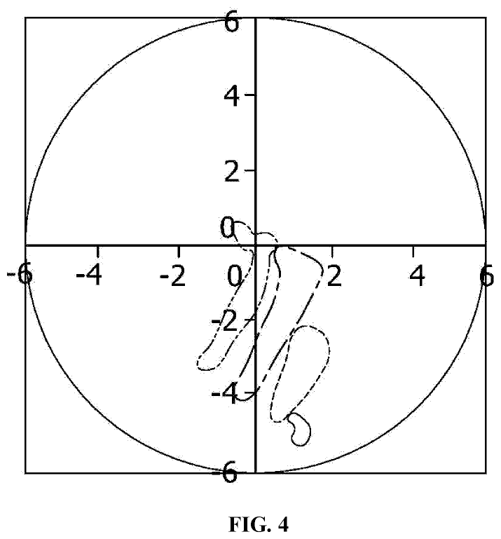

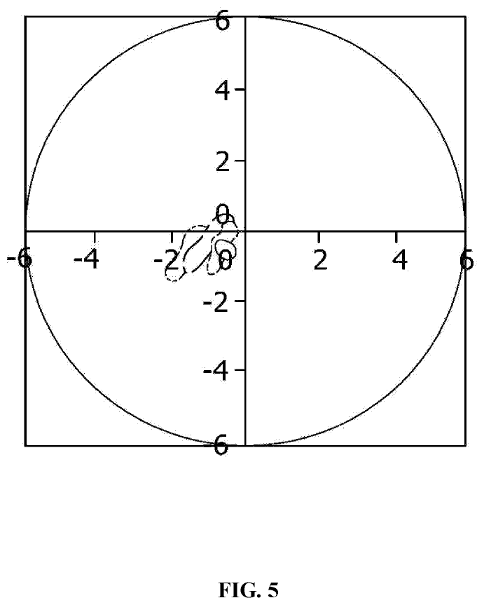

In FIGS. 4 and 5, the dashed line is 30°, the single-dot dashed line is 45°, and the double-dot dashed line is 60°.

### DETAILED DESCRIPTION OF EMBODIMENTS

With reference to the attached drawings, the present invention is described in detail by way of embodiments so that those skilled in the art can easily practice the present invention. The present invention may be embodied in various different forms and is not limited to the embodiments described herein.

In the drawings, parts that are unrelated to the description have been omitted to clearly describe the present invention, and the same or similar components have been assigned the same names throughout the specification. The lengths and sizes of each component in the drawings are for the purpose of describing the present invention, and the present invention is not limited to the lengths and sizes of each component described in the drawings.

The terms used herein are used merely to describe exemplary embodiments and are not intended to limit the present invention. Singular expressions include plural expressions unless the context clearly indicates otherwise.

In this specification, “upper” and “lower” are defined based on the drawings, and depending on the viewing angle, “upper” may be changed to “lower” and “lower” to “upper.”

Unless otherwise specifically mentioned in this specification, expressions indicated in the singular may also include the plural. In addition, unless otherwise noted, “A or B” may mean “including A, including B, or including A and B.”

In this specification, “(meth)acrylic” means acrylic and/or methacrylic.

In this specification, when indicating a numerical range, “X to Y” means X or more and Y or less (X≤ and ≤Y).

According to one embodiment, the polarizing plate may provide the effects of improving brightness, improving a bright-room contrast ratio and improving a dark-room contrast ratio. Accordingly, the polarizing plate may improve the screen quality of an optical display apparatus, for example, a liquid crystal display apparatus.

According to one embodiment, the polarizing plate may minimize a difference in reflection color values between the front surface and the side surface. Accordingly, the polarizing plate may improve the screen quality of an optical display apparatus, for example, an organic light-emitting diode display apparatus.

According to one embodiment, the polarizing plate may provide an effect of improving specular reflection. Accordingly, the polarizing plate may improve the screen quality of an optical display apparatus, for example, an organic light-emitting diode display.

The polarizing plate includes a polarizer and an upper protective film formed on a light emission surface of the polarizer, and the upper protective film includes an anti-glare layer.

The anti-glare layer does not include one or more of inorganic particles and organic particles.

By not including one or more of inorganic particles and organic particles, the wavelength influence caused by conventional inorganic particles and organic particles is minimized when external light is injected into the polarizing plate, thereby minimizing color differences on the front surface and side surface viewing angles.

Here, ‘inorganic particles’ and ‘organic particles’ may each include conventional particles known to be included in the anti-glare layer and conventional particles known to produce an anti-glare effect. For example, the inorganic particles may include spherical silica, such as a perfect sphere. For example, the organic particles may include polyalkyl (meth)acrylate-based particles, such as polymethyl methacrylate-based particles, styrene-based particles and the like.

In one embodiment, the anti-glare layer may include a dried or cured product of a composition for an anti-glare layer including one or more of a resin, an oligomer and a monomer.

Here, the resin, the oligomer and the monomer may each include a conventional resin, oligomer and monomer known to be included in an anti-glare layer.

For example, the resin may include a curable resin, and the curable resin may be one or more of a thermosetting resin and an active energy beam curable resin, and preferably, it may be an active energy beam curable resin for the ease of forming an anti-glare layer and the reliability of surface irregularities.

The active energy beam curable resin refers to a resin that is cross-linked and cured by irradiation with an active energy beam, such as ultraviolet rays or electron beams. The active energy beam curable resin may be selected to facilitate providing the refractive index of a matrix after curing. For example, for the active energy beam curable resin, an acrylic-based resin, urethane-based resin, polyester-based resin, epoxy-based resin, epoxy (meth)acrylate-based resin, or urethane (meth)acrylate-based resin may be used. Preferably, the active energy beam curable resin may be a urethane (meth)acrylate-based resin, and more preferably a polyfunctional urethane (meth)acrylate-based resin.

The oligomer may include a curable oligomer, and the monomer may include a curable monomer. The curable monomer and the curable oligomer may each improve the applicability of a composition for an anti-glare layer by increasing the curing rate of the anti-glare layer composition while lowering the viscosity. Each of the curable monomer and the curable oligomer may be active energy beam curable or thermosetting.

The active energy beam curable monomer refers to a monomer that is cross-linked and cured by irradiation with active energy beams, such as ultraviolet rays or electron beams. Active energy beam curable monomers may increase the curing rate of a composition for an anti-glare layer. For example, the active energy beam curable monomer may be selected to facilitate providing the refractive index of an anti-glare layer after curing. For example, a (meth)acrylate with 2 to 10 functional groups, for example, 2 to 6 functional groups may be appropriately used as the monomer. Bifunctional to decafunctional (meth)acrylates may be selected from types known to those skilled in the art. For example, the active energy beam curable monomer may be bifunctional acrylates such as tricyclodecane dimethanol di(meth)acrylate, 1,6-hexanediol di(meth)acrylate, neopentyl glycol di(meth)acrylate, polyethylene glycol di(meth)acrylate, neopentyl glycol adipate di(meth)acrylate, ethoxylated bisphenyl fluorene di(meth)acrylate and the like; trifunctional (meth)acrylates such as trimethylolpropane tri(meth)acrylate, dipentaerythritol tri(meth)acrylate, pentaerythritol tri(meth)acrylate, propylene oxide-modified trimethylolpropane tri(meth)acrylate; and tetrafunctional acrylates such as diglycerin tetra(meth)acrylate or pentaerythritol tetra(meth)acrylate; pentafunctional acrylates such as dipentaerythritol penta(meth)acrylate and the like; and hexafunctional acrylates such as dipentaerythritol hexa(meth)acrylate, caprolactone-modified dipentaerythritol hexa(meth)acrylate or urethane (meth)acrylates (e.g., reactants of isocyanate monomers) and trimethylolpropane tri(meth)acrylate, but is not limited thereto.

The composition for an anti-glare layer may further include an initiator.

The initiator may include one or more of a photoinitiator and a thermal initiator. The photoinitiator may include one or more of a photoradical initiator and a photocation initiator. The photoinitiator may cure active energy beam-curable resins, active energy beam-curable monomers, and active energy beam-curable oligomers. The photoradical initiator may include photoradical initiators such as acetophenone-based and cyclohexyl ketone-based photoradical initiators, but is not limited thereto.

The composition for an anti-glare layer may further include an additive.

The additive may include one or more of additives commonly used in anti-glare layers, such as surfactants, light stabilizers, UV absorbers and thermal stabilizers. The polarizing plate includes an upper protective film including the anti-glare layer, wherein in order to provide effects such as improved brightness, improved bright-room contrast ratio, improved dark-room contrast ratio, minimized difference in reflected color values between the front surface and side surface and improved specular reflection, the Sal of the upper protective film is adjusted to 7 μm or more and the internal haze to 2% or less.

It is believed that by adjusting the Sal of the upper protective film to 7 μm or more, effects such as improved brightness due to irregularities, improved reduction in contrast ratio in bright rooms, mitigation of color difference in viewing angles from the front surface and side surface, and increased brightness and improved contrast ratio may be provided, but the present invention is not limited thereto. For example, the Sal may be 7 μm or more and 50 μm or less, 12 μm or more and 40 μm or less, more than 12 μm and 30 μm or less, or more than 12 μm and 20 μm or less.

It is believed that by adjusting the internal haze of the upper protective film to 2% or less, effects such as improved brightness, improved reduction in contrast ratio in bright rooms, reduced color difference in viewing angles from the front surface and side surface, increased brightness and improved contrast ratio may be provided, but the present invention is not limited thereto. For example, the internal haze of the upper protective film may be 0 to 2%, and for example, 0% to 1%. Within the above ranges, there may be an additional effect of improving a dark-room contrast ratio.

In one embodiment, the upper protective film may have Sm of 70 μm or less, for example, 40 μm or less, for example, 10 μm to 40 μm, and for example, 20 μm to 40 μm. Within the above ranges, there may be an additional effect of increasing a contrast ratio.

In one embodiment, the upper protective film may have Ra of 1 μm or less, and for example, 0.1 to 1 μm. Within the above ranges, there may be an additional effect of increasing a contrast ratio.

In one embodiment, the upper protective film may have Ra of 1 μm or less, and for example, 0.1 to 1 μm. Within the above ranges, there may be an additional effect of increasing contrast ratio.

Surface roughness values, Ra, Sal and Sm, may each be measured by the methods described below. Ra, Sal and Sm may be measured using a Keyence VK-X1100 device. The VK-X1100 is a laser scanning scope capable of recognizing the height difference between a baseline and a surface shape and calculating various roughness formulas based on the difference between the corresponding irregularities.

In one embodiment, the upper protective film may have a total haze of 10 to 50%. By having the upper protective film with the above total haze, the polarizing plate may improve brightness and improve a reduction in contrast in dark rooms, and minimize differences in panel reflection colors at viewing angles from the front surface and side surface.

For example, the upper protective film may have a total haze of 10 to 50%, and for example, 20 to 40%. Within the above ranges, there may be further effects of improving a reduction in a contrast ratio while maintaining a glare-free function.

The upper protective film may have an external haze of 10 to 50%, and for example, 20 to 40%. Within the above ranges, the total haze and the internal haze may be easily achieved, and there may be effects such as maintaining glare-free functionality and improving bright-room and dark-room CRs.

The upper protective film may have a ratio of external haze to internal haze of 25 or more, and for example, 25 to 400. Within the above ranges, the total haze and the internal haze may be easily achieved, and there may be effects such as maintaining glare-free functionality and improving bright-room and dark-room CRs.

Here, total haze, internal haze and external haze are values measured using a haze meter in the visible light region, for example, at wavelengths of 380 to 780 nm, and unless specifically noted, they refer to average values.

Here, the internal haze is a value measured using a haze meter after laminating a laminate of an adhesive film with a total haze of less than 1% (e.g., 0 or more and less than 1%) and a triacetylcellulose (TAC) film onto an anti-glare layer (or an anti-glare layer and an anti-reflective layer) of the upper protective film. For example, it may be measured as follows:

The upper protective film was cut to a width×height (5 cm×5 cm) and fixed to the jig of a haze meter (NIPPON DENSHOKU, NDH-5000), and the total haze was measured. A laminate of an adhesive film (total haze 0%, acrylic-based) and a TAC film was prepared, the upper protective film was cut to a width×height (5 cm×5 cm), and the anti-glare layer of the upper protective film was laminated with the adhesive film, and fixed to the jig of the haze meter to measure the internal haze.

Here, the total haze is a value measured by a conventional method using a haze meter.

Here, the external haze is a value obtained by subtracting the internal haze from the total haze.

In order to implement the Ra, Sal, Sm, total haze, internal haze and external haze without including one or more of the inorganic particles and organic particles as described above, the upper protective film may be manufactured by a method described below.

The upper protective film may be manufactured by a method including forming an engraved roll having surface irregularities; applying the composition for an anti-glare layer to the engraved roll having surface irregularities to a predetermined thickness, drying and curing to form the anti-glare layer; and peeling the anti-glare layer from the engraved roll.

Since the composition for the anti-glare layer is substantially the same as described above, it is omitted here.

The applying, drying and curing of the anti-glare layer composition may be performed by employing methods known in conventional methods for forming anti-glare layers. Therefore, the detailed description thereof is omitted.

In one embodiment, the step of forming an engraved roll having surface irregularities may be manufactured by a method including forming a primary plating layer on one surface of a roll, forming primary irregularities on one surface of the primary plating layer by laser irradiating the primary plating layer, forming secondary irregularities by sanding one surface of the primary plating layer formed with the primary irregularities, and forming a secondary plating layer on the surface of the primary plating layer formed with the secondary irregularities (Method 1).

In the present invention, the step of forming primary irregularities by laser irradiation and then forming secondary irregularities by sanding processing is essentially included, rather than using only sanding processing. The laser irradiation may increase the distance between irregularities through laser processing. Therefore, the laser irradiation may significantly increase the Sal of the upper protective film.

The primary plating layer may include metal plating, such as copper plating, but is not limited thereto.

The laser irradiation may form primary irregularities on the primary plating layer by irradiating the primary plating layer with a laser. The primary irregularities may provide Sal and Sm to the upper protective film.

Specifically, primary irregularities with a fill factor of 10 to 50% may be formed by the laser irradiation. Here, the fill factor may refer to the ratio of the area of a portion where the intaglio irregularities are formed to the total area irradiated by the laser. The fill factor may be measured using a shading image processing method utilizing Mathematica. The distance between irregularities may be controlled by adjusting the fill factor (the area ratio of patterns).

Specifically, the distance between irregularities may be 30 to 500 μm, and for example, 50 to 200 μm, by the laser irradiation. Within the above ranges, the manufacture of the upper protective film may be easy.

Specifically, the angle of the laser irradiation may be set to 20 to 50°, and for example, 20 to 40°. Within the above ranges, the manufacture of the upper protective film may be facilitated.

Specifically, the size of irregularities may be controlled by changing conditions such as intensity and distance through the laser irradiation. Through this, the Sal of the upper protective film may be freely controlled.

A sanding process is performed on one surface of the primary plating layer on which the primary irregularities are formed to form secondary irregularities. The sanding process may additionally form secondary irregularities on the surface on which the primary irregularities are formed. The size of the secondary irregularities is smaller compared to the primary irregularities. The secondary irregularities may provide the Ra, Sal, Sm, internal haze, total haze and external haze of the upper protective film.

Specifically, the sanding process may be performed by spraying particles having a diameter within a predetermined range at a speed within a predetermined range and at a frequency within a predetermined range.

The secondary plating layer may be manufactured by a method including forming a secondary plating layer on the surface of the primary plating layer having the secondary irregularities formed thereon.

The secondary plating layer may increase the hardness of the engraving roll and improve leveling. The secondary plating layer may include metal plating such as copper plating, but the present invention is not limited thereto.

In another embodiment, the step of forming an engraving roll having the surface irregularities formed thereon may be manufactured by a method including forming a primary plating layer on one surface of a roll, forming primary irregularities on one surface of the primary plating layer by laser irradiating the primary plating layer, forming a secondary plating layer on one surface of the primary plating layer having the primary irregularities formed thereon, and forming secondary irregularities by sanding the surface on which the secondary plating layer is formed (Method 2).

The above method may be substantially identical to Method 1 described above, except that the order of a sanding process and the formation of the secondary plating layer is changed.

The anti-glare layer may have a thickness of 5 to 30 μm, and for example, 10 to 20 μm. It may be used in a polarizing plate within the above range.

The upper protective film may consist solely of the anti-glare layer, but in order to facilitate the formation of the upper protective film by the manufacturing method described above and increase the mechanical strength of the upper protective film, a substrate film may be further included on a lower surface of the anti-glare layer.

The substrate film may support the anti-glare layer.

The substrate film may have an external haze and an internal haze of 3% or less, and for example, 1.5% or less, respectively. Within the above range, it may not affect the overall haze of the upper protective film.

The substrate film may have a higher refractive index compared to the anti-glare layer. In one embodiment, the substrate film may have a refractive index of 1.4 to 1.8, specifically 1.45 to 1.8, 1.5 to 1.75, or 1.55 to 1.70.

The substrate film may have a thickness of 15 to 250 μm, and preferably 40 to 60 μm. Within the above range, it may function as a support for the upper protective film.

The substrate film may be a film including an optically transparent resin. For example, the substrate film may be a film made of one or more resins selected from cellulose-based resins including triacetylcellulose, polyester-based resins including polyethylene terephthalate, polybutylene terephthalate, polyethylene naphthalate and polybutylene naphthalate, acrylic-based resins, cyclic polyolefin-based resins, polycarbonate-based resins, polyethersulfone-based resins, polysulfone-based resins, polyamide-based resins, polyimide-based resins, polyolefin-based resins, polyarylate-based resins, polyvinyl alcohol-based resins, polyvinyl chloride-based resins and polyvinylidene chloride-based resins. In one embodiment, the substrate film may have birefringence to allow rainbow streaks to be visible. In this regard, the substrate film may be a triacetylcellulose film or a polyethylene terephthalate film.

The substrate film may be manufactured by melt extrusion or solution casting of a composition for a substrate film including the above resin. Alternatively, the substrate film may be manufactured by stretching a non-stretched film manufactured by the melt extrusion or solution casting at a predetermined stretching ratio. The stretching temperature may be controlled according to the glass transition temperature (T_{g}) of the unoriented film, for example, T_{g}±20 °C. Stretching may be performed by conventional methods known to those skilled in the art.

The substrate film may further have a primer layer as a functional layer on at least one surface of the substrate film. The primer layer may enhance adhesion to the substrate or the anti-glare layer. The primer layer may be formed from a composition including a resin for the primer layer, such as a urethane-based, acrylic-based or polyester-based resin, within a range that does not affect the effect of the polarizing plate.

The upper protective film may consist solely of the anti-glare layer, but in order to reduce reflectivity, it may further include an anti-reflective layer or anti-reflective particles on the other surface of the anti-glare layer.

The anti-reflection particles may include one or more of low-refractive-index particles and particles surface-treated with a fluorine-based compound.

The low-refractive-index particles may be particles having a refractive index lower than that of the anti-glare layer. For example, the low-refractive-index particles may have a hollow structure to have a low refractive index. For example, hollow silica may be preferred as the low-refractive-index inorganic particles. The refractive index may be less than 1.4, for example, between 1.0 or more and less than 1.3. Within the above ranges, the refractive index of the anti-reflection layer may be easily lowered.

The low-refractive-index particles have a low average particle size (D50) compared to the thickness of the anti-reflection layer, and for example, the average particle size (D50) may be 20 nm to 120 nm, for example, between 40 nm and 100 nm. Within the above ranges, they may be contained in the anti-reflection layer.

The polarizing plate may further include a polarizer and a lower protective film in addition to the upper protective film.

### Polarizer

The polarizer is a linear light-absorbing polarizer that can provide a polarization function by transmitting only light in one direction among the incident light and absorbing light in a direction perpendicular to the one direction.

In one embodiment, the direction of the light absorption axis of the polarizer and the mechanical direction of the substrate film may be substantially parallel.

The polarizer is a polyvinyl alcohol (PVA)-based film polarizer. Here, “polyvinyl alcohol-based” may refer not only to polyvinyl alcohol itself but also to derivatives of polyvinyl alcohol. Preferably, the polarizer may be a polyvinyl alcohol derivative film polarizer.

In one embodiment, the polyvinyl alcohol derivative contains hydrophilic functional groups and hydrophobic functional groups. Hydrophobic functional groups are additionally present in addition to hydroxyl groups (OH groups), which are hydrophilic functional groups present in polyvinyl alcohol. Hydrophobic functional groups may be present in one or more of a main chain and side chains of the polyvinyl alcohol derivative resin. The “main chain” refers to a portion forming the main framework of the polyvinyl alcohol derivative, and the “side chain” refers to a framework connected to the main chain. Preferably, hydrophobic functional groups may be present in the main chain of the polyvinyl alcohol derivative.

A polyvinyl alcohol derivative introduced with hydrophilic and hydrophobic functional groups may be prepared by polymerizing one or two or more monomers of vinyl ester, such as vinyl acetate, vinyl formate, vinyl propionate, vinyl butyrate, vinyl pivalate and isopropene acetate, with a monomer providing hydrophobic functional groups. Preferably, the vinyl ester monomer may include vinyl acetate. The monomer providing hydrophobic functional groups may include a monomer providing hydrocarbon repeating units, such as ethylene and propylene.

The polyvinyl alcohol-based film may have a thickness of 60 μm or less, and for example, 10 μm to 60 μm. Within the above ranges, there may be no melting or breakage of the film during film stretching.

For the polyvinyl alcohol-based film, TS-#4500 (hereinafter, Kuraray, Japan) PVA film may be used, but is not limited thereto.

The polarizer is a polarizer to which a dichroic material is applied. The dichroic material may be an iodine-based material, or a dichroic dye such as an azo dye may be applied. Generally, polarizers to which an iodine-based material is applied may be classified as iodine-based polarizers, and polarizers to which a dichroic dye is applied may be classified as dye-based polarizers. In the present invention, both iodine-based polarizers and dye-based polarizers may be used.

The thickness of the polarizer may be 25 μm or less, for example, more than 0 μm and 25 μm or less, and for example, 10 μm to 20 μm. Within the above ranges, it may be used in a polarizing plate.

### Lower Protective Film

The lower protective film may improve a contrast ratio by providing an optical compensation function for the polarizing plate.

The lower protective film may have a total haze of 0 to 1%, an internal haze of 0 to 1%, and an external haze of 0 to 1%. Within the above ranges, it may not affect the effects of the present invention.

The lower protective film may have a thickness of more than 0 and 60 μm or less, and for example, 30 to 55 μm. Within the above ranges, it may be used in a polarizing plate.

The lower protective film may be a film including an optically transparent resin. For example, the lower protective film may be a film made of one or more resins selected from cellulose-based resins including triacetylcellulose (TAC), polyester-based resins including polyethylene terephthalate (PET), polybutylene terephthalate, polyethylene naphthalate and polybutylene naphthalate, acrylic-based resins, cyclic olefin polymer (COP)-based resins, amorphous polyolefin (COC)-based resins, polycarbonate-based resins, polyethersulfone-based resins, polysulfone-based resins, polyamide-based resins, polyimide-based resins, polyolefin-based resins, polyarylate-based resins, polyvinyl alcohol-based resins, polyvinyl chloride-based resins, polyvinylidene chloride-based resins and acrylic-based resins. Preferably, the lower protective film may be a cyclic olefin polymer (COP)-based or amorphous polyolefin (COC)-based film.

The lower protective film may be manufactured by melt extrusion or solvent casting of a composition for a non-stretched film for the lower protective film. Additionally, the non-stretched film may have an in-plane phase difference as described above through stretching and the like.

The lower protective film may be attached to the polarizer by an adhesive layer formed of a water-based or photocurable adhesive.

An adhesive layer, such as a pressure-sensitive adhesive layer (PSA), may be further laminated on the lower surface of the lower protective film to attach the polarizing plate to a panel and the like.

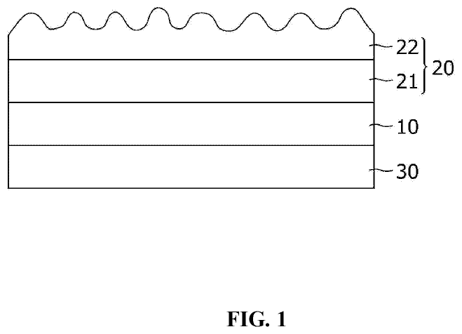

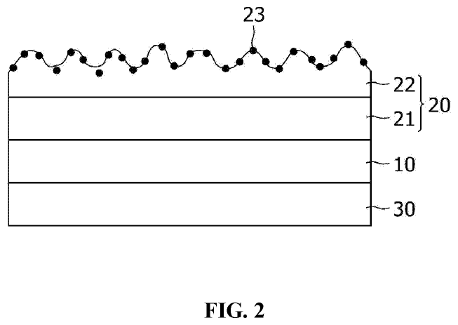

FIGS. 1 and 2 are cross-sectional diagrams of a polarizing plate according to one embodiment.

Referring to FIG. 1, the polarizing plate includes a polarizer 10, a lower protective film 20 laminated on a light incident surface of the polarizer 10, and an upper protective film 20 laminated on a light emission surface of the polarizer 10, wherein the upper protective film 20 includes a substrate film 21 and an anti-glare layer 22 laminated on one surface of the substrate film 21.

Referring to FIG. 2, the polarizing plate includes a polarizer 10, a lower protective film 20 laminated on a light incident surface of the polarizer 10, and an upper protective film 20 laminated on a light emission surface of the polarizer 10, wherein the upper protective film 20 includes a substrate film 21, an anti-glare layer 22 laminated on one surface of the substrate film 21, and anti-reflection particles 23 dispersed on one surface of the anti-glare layer 22.

According to another embodiment, the optical display apparatus includes the polarizing plate of the present invention.

The optical display apparatus may include liquid crystal display devices, organic light-emitting diode display devices, and light-emitting diode display devices.

Hereinafter, the constitutions and operations of the present invention will be explained in more detail below through preferred embodiments of the present invention. However, these are presented as preferred examples of the present invention and should not be interpreted in any way as limiting the present invention.

### Example 1

### (1) Manufacture of Polarizer

A polyvinyl alcohol film (TS-#4500, Kuraray, Japan; thickness: 45 μm) washed with water at 25 °C was subjected to swelling treatment in a swelling tank with water at 30 °C. The film that passed through the swelling tank was treated for 65 seconds in a dyeing tank at 30 °C containing an aqueous solution including 0.8 wt % potassium iodide and 0.5 wt % boric acid to dye the film. A polarizer was manufactured by stretching the film that passed through the dyeing bath at a stretching ratio of approximately 6 times in a wet stretching bath containing a 60 °C aqueous solution containing 3.6 wt % boric acid and 3.5 wt % potassium iodide.

### (2) Upper Protective Film

For an upper protective film, a film in which a substrate film and an anti-glare layer were laminated on one surface of the substrate film was used.

The substrate film is a polyethylene terephthalate film (Toyobo).

The anti-glare layer was manufactured using a solvent-free type UV-curing resin (Shin-A) without inorganic or organic particles. Specifically, the anti-glare layer was manufactured by transferring a pattern directly engraved on a roll onto the substrate film using UV resin in a roll-to-roll manner.

The upper protective film has the internal haze and total haze shown in Table 1 below. Internal haze and total haze were measured using the haze meter NDH-5000 (NIPPON DENSHOKU) in the method described above.

The upper protective film has the Ra, Sal, and Sm values shown in Table 1 below. Ra, Sal and Sm were measured using the Keyence VK-X1100 device in the manner described above.

### (3) Lower Protective Film

A cyclic olefin polymer-based film was used for a lower protective film.

### (4) Manufacture of Polarizing Plate

A polarizing plate was manufactured by bonding the upper protective film to an upper surface of the polarizer manufactured above using a UV-curing adhesive, and bonding the lower protective film to a lower surface of the polarizer using a UV-curing adhesive.

### Example 2

### (1) Upper Protective Film

An upper protective film was manufactured in the same manner as in Example 1, except that a pattern was designed in which the Sal was reduced by making the size of irregularities smaller compared to Example 1 during roll processing by laser processing in Example 1.

### (2) Polarizing Plate

A polarizing plate was manufactured in the same manner as in Example 1, except that the above upper protective film was used.

### Example 3

### (1) Upper Protective Film

An upper protective film was manufactured in the same manner as in Example 1, except that a pattern was designed in a direction of increasing the Sal by making the size of irregularities larger compared to Example 1 during roll processing by laser processing in Example 1.

### (2) Polarizing Plate

A polarizing plate was manufactured in the same manner as in Example 1, except that the above upper protective film was used.

### Example 4

### (1) Upper Protective Film

An upper protective film was manufactured in the same manner as in Example 1, except that a pattern was designed in a direction of increasing Sm by reducing the size of irregularities compared to Example 1 during roll processing by laser processing in Example 1, thereby reducing the Sal, and adjusting the fill factor of the pattern to control the distance between irregularities.

### (2) Polarizing Plate

A polarizing plate was manufactured in the same manner as in Example 1, except that the above upper protective film was used.

### Comparative Example 1

### (1) Upper Protective Film

For the upper protective film, a film (LRH25, DNP) in which a substrate film and an anti-glare layer were laminated on one surface of the substrate film was used. The substrate film is a triacetylcellulose film, and the anti-glare layer includes silica.

### (2) Polarizing Plate

A polarizing plate was manufactured in the same manner as Example 1, except that the above upper protective film was used.

### Comparative Example 2

### (1) Upper Protective Film

An upper protective film was manufactured in the same manner as Example 1, except that a pattern was designed in a direction of increasing Sm by controlling the distance between irregularities by adjusting the fill factor of the irregularities during roll processing by laser processing in Example 1.

### (2) Polarizing Plate

A polarizing plate was manufactured in the same manner as Example 1, except that the above upper protective film was used.

### Evaluation in Liquid Crystal Display Apparatus

An evaluation model was prepared by removing a viewing-side polarizing plate from a liquid crystal panel model, laminating the polarizing plates manufactured in the examples and comparative examples as the viewing-side polarizing plates, and aging for 60 minutes to stabilize the brightness. In this case, among the polarizing plates, the upper protective film was positioned at the outermost edge of the viewing side.

The following physical properties were evaluated using the prepared evaluation model, and the results are shown in Table 1 below.

Contrast ratio (CR) and brightness: After driving the above model, brightness was measured in both a bright room and a dark room using the EZ-CONTEST (EILDIM) brightness meter.

Brightness in a white mode and frontal brightness in a black mode were measured in a bright room environment, and the ratio of the brightness in the white mode to the brightness in the black mode was calculated. The relative brightness ratio based on the brightness ratio calculated in Comparative Example 1 was described in Table 1 as a bright-room contrast ratio.

In a dark room environment, the brightness in a white mode and the frontal brightness in a black mode were measured, respectively, and the ratio of the brightness in the white mode to the brightness in the black mode was calculated. The relative brightness ratio based on the brightness ratio calculated in Comparative Example 1 was described in Table 1 as a dark-room contrast ratio.

The ratio of the frontal brightness of the examples and comparative examples based on the frontal brightness of Comparative Example 1 was calculated.

### Evaluation in Organic Light-Emitting Diode Display Apparatus

Reflective color value Δa*b*:

An evaluation model was prepared by removing a polarizing plate from a display apparatus having an organic light-emitting diode panel, laminating the polarizing plates manufactured in the examples and comparative examples as the viewing-side polarizing plates, and aging for 60 minutes to stabilize the brightness. In this case, among the polarizing plates, the upper protective film was positioned at the outermost edge of the viewing side.

When the evaluation model was driven using the prepared evaluation model, the reflective color values on the front surface and side surface (60° viewing angle) were obtained, and the difference in reflective color values between the front surface and side surface, Δa*b*, was calculated. Δa*b* is the distance between the front-surface and the side-surface color values (a*, b*).

Specular reflection: It was evaluated by comparing the degree of glare-free effects by reflecting a tri-phosphor lamp at a certain distance by the naked eye. Cases with no glare were evaluated as ∘, cases with slight glare were evaluated as Δ, and cases with severe glare were evaluated as x.

TABLE 1

| | | Example | | | | Comparative Example | |
|---|---|---|---|---|---|---|---|
| | | 1 | 2 | 3 | 4 | 1 | 2 |
| Upper protective film | Ra (μm) | 0.4 | 0.4 | 0.4 | 0.4 | 0.4 | 0.4 |
| | Sal (μm) | 13 | 7 | 20 | 7 | 7 | 13 |
| | Sm (μm) | 35 | 35 | 35 | 70 | 50 | 50 |
| | Total haze (%) | 25 | 25 | 25 | 25 | 25 | 25 |
| | Internal haze (%) | 0.2 | 0.2 | 0.2 | 0.2 | 10 | 10 |
| Dark-room contrast ratio (%) | | 120 | 120 | 120 | 120 | 100 | 100 |
| Bright-room contrast ratio (%) | | 120 | 110 | 130 | 130 | 100 | 100 |
| Front-surface brightness (%) | | 101 | 101 | 102 | 102 | 100 | 100 |
| Reflective color | Δa*b* | 1.5 | 1.5 | 1.5 | 1.5 | 4.3 | 4.3 |
| Specular reflection | Naked eye | ◯ | Δ | ◯ | X | ◯ | ◯ |

As can be seen from Table 1 above, the polarizing plates of the examples provided the effects of improved brightness, improved bright-room contrast ratio and improved dark-room contrast ratio, minimized the difference in reflection color values between the front surface and side surface, and provided an effect of improved specular reflection.

However, the polarizing plates of the comparative examples did not show much improvement compared to the polarizing plates of the examples.

Simple variations or modifications of the present invention can be easily implemented by those skilled in the art, and all such variations or modifications are considered to be included within the scope of the present invention.

1. A polarizing plate, comprising:
a polarizer; and an upper protective film positioned on a light emission surface of the polarizer,
wherein the upper protective film comprises an anti-glare layer,
wherein the anti-glare layer does not comprise one or more of inorganic particles and organic particles, and
wherein the upper protective film has Sal of 7 μm or more and an internal haze of 2% or less.

2. The polarizing plate of claim 1, wherein the upper protective film has Ra of 1 μm or less.

3. The polarizing plate of claim 1, wherein the upper protective film has Sm of 70 μm or less.

4. The polarizing plate of claim 1, wherein the upper protective film has a total haze of 10 to 50% and an internal haze of 0 to 1%.

5. The polarizing plate of claim 1, wherein the upper protective film has an external haze of 10 to 50%.

6. The polarizing plate of claim 1, wherein the upper protective film further comprises a substrate film positioned on one surface of the anti-glare layer.

7. The polarizing plate of claim 1, wherein the upper protective film further comprises anti-reflective particles positioned on one surface of the anti-glare layer.

8. An optical display apparatus, comprising the polarizing plate according to claim 1.
